(19) United States
(12) Patent Application Publication
(10) Pub. No.: US 2017/0051236 A1
(43) Pub. Date: Feb. 23, 2017

(54) Emulsifier Process Aids for Hops

(71) Applicant: PicoBrew, LLC, Seattle, WA (US)

(72) Inventor: James B. Mitchell, Seattle, WA (US)

(21) Appl. No.: 14/831,635

(22) Filed: Aug. 20, 2015

(51) Int. Cl. C12C 3/00

(52) U.S. Cl. CPC C12C 9/02

(57) ABSTRACT

An emulsifier process aid may increase the bittering effect of hops in the beer making process, which may reduce the length of time for boiling while using less hops. An emulsifier, such as lecithin, may be added to the hops during pelletization or other processing steps, or may be added to the boil directly. The emulsifier may cause the hop oils to be more readily absorbed into the wort and act as a process aid to increase efficiency of the boil and hops utilization.

### BACKGROUND

The process of making beer dates back millennia. In general, sugars are extracted from malted grains through enzymatic reaction that converts starches to sugars, then this extract is boiled with hops to create beer wort, which is then fermented with yeast to produce beer.

Hops (Humulus lupulus) are a traditional ingredient that adds bitterness, flavor, and aroma to the finished beer. Bittering hops are conventionally added during the boil, which may last an hour or longer. Flavor hops and aroma hop additions are added near the end of the boil or even afterwards during fermentation.

### SUMMARY

An emulsifier process aid may increase the bittering effect of hops in the beermaking process, which may reduce the length of time required for beer wort boiling and/or allow the use of less hops. An emulsifier, such as lecithin, may be added to the hops during pelletization, or may be added to the boil directly. The emulsifier may cause the hop oils to be more readily absorbed into the wort and act as a process aid to increase efficiency of the boil and hops utilization.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a flowchart illustration of an embodiment showing a method for making beer.

FIG. 2 is a flowchart illustration of an embodiment showing several methods for manufacturing hops with an emulsifier.

### DETAILED DESCRIPTION

Emulsifier Process Aids for Hops

An emulsifier, such as lecithin, may increase hops utilization in beermaking, specifically in the wort manufacture process. The addition of small amounts of lecithin has been shown to dramatically increase the perceived bittering effects of hops, thereby lowering the amount of hops used to achieve a desired bittering effect. Further, the use of an emulsifier has also been shown to reduce the length of boil required for wort manufacture targeting a specific bitterness.

Lecithin and other emulsifiers can be classified as amphipathic, meaning that they may possess both hydrophilic and lipophilic properties. Such materials may readily bind the water-based wort with the fat or oil-based hops oils.

During the boil phase of wort manufacture, the length of time of the boil directly contributes to the extraction of bittering agents from the hops. In many cases, wort may be boiled for an hour or longer to extract the bittering oils from the hops. One of the reasons why the extraction takes a long time is that the bittering oils from the hops do not readily assimilate into the wort.

A side effect of the long boil cycle is that some or all of the hop oils are driven off during the boil. These oils tend to have a lower boiling point and often contribute to the aroma and flavor of the beer, hence a separate hops charge may need to be added near the end of the boil or during fermentation for aroma and flavor.

Emulsifiers, such as lecithin, may work by helping to bind the oil-based hops components to the water based wort. Even small amounts of lecithin added to a boil can reduce the amount of hops required and decrease the length of the boil cycle for wort manufacture.

Tests have shown that 1% to 2% by weight or less of lecithin emulsifier can dramatically increase the bittering effects of beer brewed with the same amount of hops. Amounts as little as 0.5% or even 0.1% or 0.05% by weight can have noticeable effects.

Boil time for a given recipe can be reduced by half or even more in some cases by using an emulsifier. Such a reduction may be useful in commercial and home brewing applications. For commercial applications, a reduction in boil time can improve capital efficiency by doubling the throughput of the factory, while in home brewing applications, a reduced boil cycle may reduce a user's time commitment to brewing their own beer.

The amount of hops can be reduced dramatically when using an emulsifier, even with a reduced boil cycle. As hops are one of the most expensive ingredients in beer, a reduction in hops usage may translate directly into cost savings for a brewery.

Hops extraction during the boil cycle is a function of time, such that the longer the boil cycle, the more hops extraction may be achieved. The use of an emulsifier may allow a much shorter boil cycle with the same amount of hops, a much lower amount of hops for the same length of boil time, or a combination or tradeoff between boil time and amount of hops. Such a tradeoff may be made by a brewer to meet a cost/time objective.

An emulsifier may be added in liquid or powdered form, and may be added directly to a boil kettle or added to the hops prior to adding to the boil kettle.

Whole or pelletized hops may be treated with an emulsifier prior to packaging and distribution to a brewery. The emulsifier may be applied by dusting the hops with a powdered emulsifier, spraying or misting the hops with a liquid emulsifier, or other application mechanisms.

Pelletized hops may have an emulsifier added during pelletization. The hops may be treated with a mist or powdered form of an emulsifier prior to pelletization such that the pelletized hops may contain a dose of emulsifier.

Whole hops may be pelletized by processing through a shredder or hammer mill, then using a pellet mill to form pellets, such as a flat die pellet mill or ring die pellet mill. An emulsifier may be added in powder form or liquid prior to or after a hammer mill operation and prior to the pelletization step. In some cases, hops may be pelletized and then have an emulsifier added in powder or liquid form.

In some cases, whole hops may be compressed into plugs. Such a form may have an emulsifier added prior to or after compressing into plugs. Plugs typically are manufactured without first processing through a hammer mill or undergoing a chopping or cutting process.

An emulsifier may improve bittering characteristics of hops in a beer but may have adverse effects on flavor and aroma hops. Flavor and aroma hops may give their effect by offgassing the flavor and aroma essences, and such an effect may be impeded by the binding effects of an emulsifier. As such, some beer recipes may be adjusted to increase flavor or aroma hops to compensate for the use of an emulsifier. In some cases, emulsifiers may be used for certain beer styles that have high bittering components and have less emphasis on flavor or aroma hops.

An emulsifier may be classified as a process aid for making beer. Small amounts of emulsifiers have been shown to have a functional effect of increasing the bitterness obtained from hops. Such emulsifiers may not have a technical or functional effect on the resulting beer, but may be present in insignificant levels. In many cases, emulsifiers may be certified organic.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

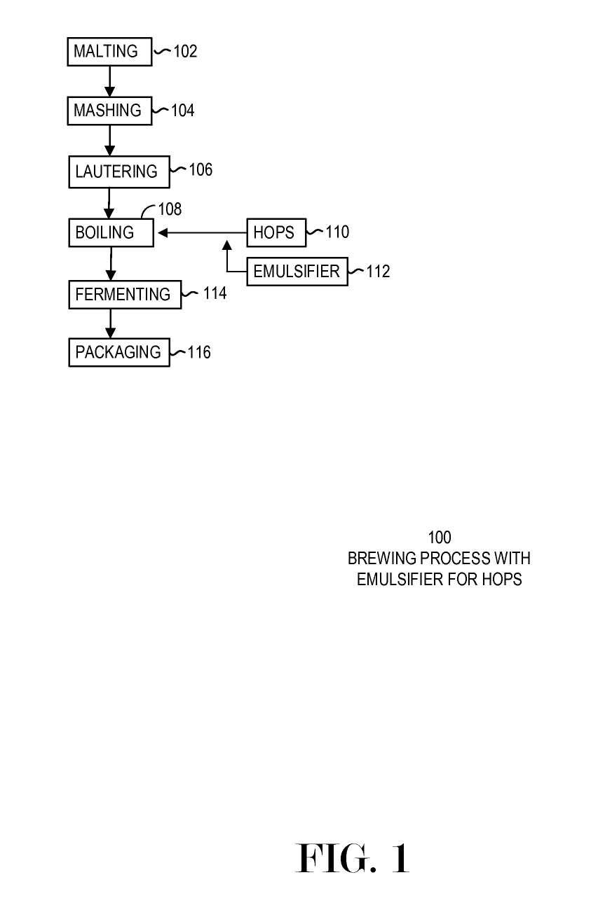

FIG. 1 is a flowchart illustration of an embodiment 100 showing a beer brewing process that includes an emulsifier added during the boiling step.

Beer making conventionally begins with malting grains in block 102. The grains typically are barley, but other grains may also be used including rice, wheat, and oats. The grains are added to water and mashed in block 104, where starches in the grains are converted to sugars through various enzymes. A lautering process shown in block 106 is where the sugars are separated from the grains into a liquid known as wort.

The wort is boiled in block 108, at which point hops 110 and an emulsifier 112 are added. For many beers, hops may be added in several stages, with the earliest hops being added primarily for bittering effects, and later hops being added for flavor and still other hops added later for aroma. The selection of hops and the schedule for adding the hops may be varied for different styles and recipes of beer.

A fermentation step 114 is where yeast is added, and the yeast converts the sugars in the wort to alcohol and carbon dioxide. The resultant beer is packaged in block 116.

Many brewers may have additional steps, such as whirlpooling, chilling, or other steps.

The emulsifier 112 may be added directly to the vessel in which boiling is performed, or the emulsifier 112 may be added to the hops 110 prior adding to the boil step.

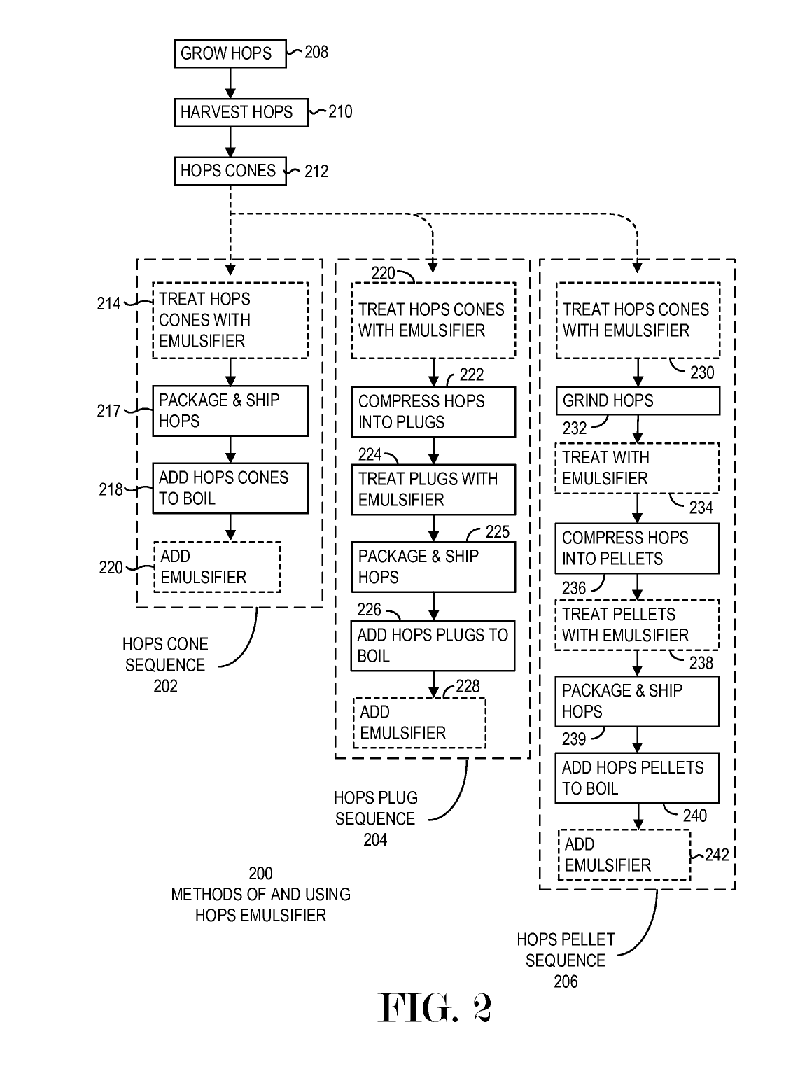

FIG. 2 is a diagram illustration of an embodiment 200 showing several ways hops may be processed and prepared for beermaking. The sequences of embodiment 200 illustrate hops being used in their whole or cone form 202, in a compressed plug form 204, or in a pellet form 206. Embodiment 200 illustrates various points where an emulsifier may be added during the process.

Emulsifiers, such as lecithin, may come in a powdered, liquid, or other form. In some cases, an emulsifier may be added to hops prior to use. In other cases, emulsifiers may be added directly to a boil vessel without first being added to the hops.

Hops may be prepared prior to use by treating the hops with an emulsifier prior to packaging and shipping to a brewer. The treatment may be done at a processing facility that may receive freshly picked hops, process the hops, and package the hops for shipment. The processing operations may include grading, sorting, creating plugs or pellets, or other operations. In many cases, hops are packaged in various manners so that the hops may be used throughout the year.

The packaged hops may be pretreated with emulsifier when shipped. In some cases, a brewer may receive untreated hops, then apply emulsifier to the hops prior use. In still other cases, a brewer may receive and use untreated hops, then add emulsifier into a boil cycle to increase hops utilization.

Hops may be used in three conventional manners, although other forms are also possible. Many brewers may use hops in their “cone” state, which is the hops flower in a dried but otherwise unprocessed state. Hops plugs are the full hops cones that may be pressed into plugs that may have an approximate diameter of 0.5 to 1 inch and a thickness of ⅜ to ½ inch, although other sizes are used as well. Hops pellets are typically ground and pressed pellets that may be ¼ in diameter and ¼ to ½ inch long cylinders.

Prior to use, hops are grown in block 208 and harvested in block 210 to produce hops cones in block 212. The hops cones are the flower of the hops plant (Humulus lupulus).

When used as whole hops in sequence 202, the hops cones may be treated with emulsifier in block 214. The hops may be packaged and shipped in block 217.

The treated hops may be added to the boil step in block 218. When untreated whole hops are used, an emulsifier may be added directly to the boil in block 220.

When hops plugs are used in sequence 204, the hops cones may be treated with an emulsifier in block 220 and compressed into plugs in block 222. The plugs may be treated with emulsifier in block 224. The hops may be packaged and shipped in block 225 with the emulsifier.

The hops plugs may be added to the boil in block 226. When untreated plugs are used, an emulsifier may be added directly to the boil in block 228.

When hops pellets are used in sequence 206, the hops cones may be treated with an emulsifier in block 230 prior to grinding the hops in block 232. In some cases, the ground hops may be treated with an emulsifier in block 234 prior to compressing the ground hops into pellets in block 236. The pellets may be treated with an emulsifier in block 238 prior to packaging and shipping the pelletized hops.

The treated hops may be added to the boil in block 240. When untreated pellets are used, an emulsifier may be added directly to the boil in block 242.

Hops may be treated with an emulsifier in the whole cone state, as in blocks 214, 220, and 230 or prior to pelletizing such as in block 234. Such a treatment may include dusting the hops cones with a powdered emulsifier, misting the hops cones with an aerosolized liquid emulsifier, mixing or tumbling the hops cones with a powdered or liquid emulsifier, or any other treatment. Once treated, the hops may be processed and used in a conventional manner.

Hops may be treated with an emulsifier in a compressed to pelletized state, such as in blocks 224 and 238. Such a treatment may coat the exterior of a plug or pellet with an emulsifier. Such a treatment may involve spraying or dusting the plugs or pellets, tumbling the plugs or pellets with emulsifier, or other application.

In many cases, the emulsifier may be applied using a solvent or dispersant.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A process comprising:
receiving wort comprised of sugars extracted from at least one malted grain;
adding hops and an emulsifier to said wort;
bringing said wort, said hops, and said emulsifier to a boil; and
cooling said wort, said hops, and said emulsifier.

2. The process of claim 1, said emulsifier being a powdered emulsifier.

3. The process of claim 1, said emulsifier being a liquid emulsifier.

4. The process of claim 1, said emulsifier being lecithin.

5. The process of claim 1, said hops and said emulsifier being combined prior to said adding said hops and said emulsifier to said wort.

6. The process of claim 5, said hops being in the form of hops pellets, said emulsifier being added during pelletization.

7. The process of claim 5, said hops being in the form of hops plugs, said emulsifier being added during manufacturing said hops plugs.

8. The process of claim 1, said emulsifier being less than 2% by weight of said hops.

9. The process of claim 1, said emulsifier being less than 1% by weight of said hops.

10. The process of claim 1, said emulsifier being less than 0.5% by weight of said hops.

11. The process of claim 1, said emulsifier being less than 0.1% by weight of said hops.

12. The process of claim 1, said emulsifier being less than 0.05% by weight of said hops.

13. A compressed hops product comprising:
a quantity of hops cones; and
an emulsifier.

14. The compressed hops product of claim 13, said emulsifier comprising lecithin.

15. The compressed hops product of claim 13, said emulsifier being less than 2% by weight of said hops.

16. The compressed hops product of claim 13, said emulsifier being less than 1% by weight of said hops.

17. The compressed hops product of claim 13, said emulsifier being less than 0.5% by weight of said hops.

18. The compressed hops product of claim 13, said emulsifier being less than 0.1% by weight of said hops.

19. The compressed hops product of claim 13, said emulsifier being less than 0.05% by weight of said hops.

20. The compressed hops product of claim 13, said emulsifier being applied to the exterior of said hops pellet.

21. The compressed hops product of claim 13, said emulsifier being comprised within said hops product.

22. A method of manufacture for a compressed hops product, said method comprising:
compressing hops cones into a compressed hops product; and
adding an emulsifier to said compressed hops product.

23. The method of claim 1, said method further comprising:
adding said emulsifier prior to said compressing.

24. The method of claim 1, said method further comprising:
adding said emulsifier after said compressing.

25. The method of claim 24, said emulsifier being a mist applied to said compressed hops product.

26. The method of claim 24, said emulsifier being a powder applied to said compressed hops product.

27. The method of claim 24, said method further comprising:
grinding said hops cones prior to said compressing.

28. The method of claim 22, said emulsifier being lecithin.

29. The method of claim 22, said emulsifier being less than 2% by weight of said hops.

30. The method of claim 22, said emulsifier being less than 1% by weight of said hops.

31. The method of claim 22, said emulsifier being less than 0.5% by weight of said hops.

32. The method of claim 22, said emulsifier being less than 0.1% by weight of said hops.

33. The method of claim 22, said emulsifier being less than 0.05% by weight of said hops.
